(19) United States
(12) Patent Application Publication
(10) Pub. No.: US 2025/0013856 A1
(43) Pub. Date: Jan. 9, 2025

(54) ANALOG IN-SENSOR COMPUTING DEVICE AND ELECTRONIC DEVICE INCLUDING SAME

(71) Applicant: SAMSUNG ELECTRONICS CO., LTD., Suwon-si (KR)

(72) Inventors: Min Young MUN, Suwon-si (KR); Seok Ju YUN, Suwon-si (KR); Sei Joon KIM, Suwon-si (KR); Sang Joon KIM, Suwon-si (KR)

(73) Assignee: SAMSUNG ELECTRONICS CO., LTD., Suwon-si (KR)

(21) Appl. No.: 18/640,853

(22) Filed: Apr. 19, 2024

(30) Foreign Application Priority Data
Jul. 6, 2023 (KR) 10-2023-0087968
Nov. 20, 2023 (KR) 10-2023-0160428

(51) Int. Cl. G06N 3/0464

(52) U.S. Cl. CPC G06N 3/0464

(57) ABSTRACT

A convolutional neural network (CNN)-based analog in-sensor computing device may include a convolution layer including one or more convolution blocks configured to be used a predetermined number of times or more and perform a convolution operation, and an memory configured to temporarily store an output of the convolution layer and provide the stored analog output to a subsequent convolution layer.

### CROSS-REFERENCE TO RELATED APPLICATION(S)

This application claims priority from Korean Patent Application No. 10-2023-0087968, filed on Jul. 6, 2023 and Korean Patent Application No. 10-2023-0160428, filed on Nov. 20, 2023 in the Korean Intellectual Property Office, the disclosures of which are incorporated herein by reference in their entireties.

### BACKGROUND

### 1. Field

The following description relates to an analog in-sensor computing device that performs a low-power operation.

### 2. Description of Related Art

“Computer offloading” refers to the transfer of resource-intensive computing tasks to separate devices or external platforms such as the cloud.

“Computer offloading to sensor” is also known as in-sensor computing (ISP), wherein computing operations are directly performed within a sensor module to reduce the computational load on a central processor.

“Analog in-sensor computing” exploits the analog characteristics of sensor data within the sensor module to carry out, for example, artificial intelligence (AI) operations in the analog domain. This approach is attracting attention due to its advantages such as low latency and low-power computing.

### SUMMARY

According to an aspect of the present disclosure, a convolutional neural network (CNN)-based analog in-sensor computing device may include: a convolution layer including one or more convolution blocks configured to be used a predetermined number of times or more and perform a convolution operation; and a memory configured to temporarily store an analog output of the convolution layer and provide the stored analog output to a subsequent convolution layer.

The memory may include a plurality of capacitors.

A number of the plurality of capacitors may be set based on a data size of an output feature map of the convolution layer.

In the memory, a capacitor in which the analog output of the convolution layer is to be stored may be randomly selected from the plurality of capacitors.

In the memory, the analog output of the convolution layer may be upscaled or downscaled before being stored in one of the plurality of capacitors.

The analog in-sensor computing device may further include a plurality of memories including the memory, and a plurality of convolution layers including the convolution layer and the subsequent convolution layer, wherein a number of the plurality of memories may be equal to a number of the plurality of convolution layers.

The analog in-sensor computing device may further include a plurality of memories including the memory, and a plurality of convolution layers including the convolution layer and the subsequent convolution layer, wherein a number of the plurality of memories may be less than a number of the plurality of convolution layers.

The analog in-sensor computing device may further include a processor configured to control connections of the plurality of convolution layers to allow the plurality of convolution layers to share at least one of the plurality of memories.

The plurality of memories may include a first memory and a second memory, memory capacity of a total number of capacitors included in the first memory and the second memory is greater than or equal to a sum of a data size of an output feature map of a last convolution layer of a convolutional neural network including the plurality of convolution layers and a data size of an output feature map of a convolution layer immediately preceding the last convolution layer.

The memory may include a main memory and a reference memory, a time sequence of an output stored in the main memory is reversed compared to a time sequence of an output stored in the reference memory, and the output stored in the main memory and the output stored in the reference memory are averaged when the output is read.

The convolution block may include a crossbar array and when input data is received through multiple input channels, a value of each of the multiple input channels is formed in each row of the crossbar array, and each column of the crossbar array may be formed as a convolution filter.

The convolution block may include a crossbar array, and when input data is received through a single channel, a number of rows of the crossbar array may be determined based on a size of a convolution filter.

The memory may include a capacitor, and the predetermined number of times may be determined based on at least one of a retention time of the capacitor or a driving frequency of the one or more convolution blocks.

The retention time of the capacitor may be determined based on at least one of specifications of the capacitor, a size of each layer of a convolutional neural network, or a driving voltage.

According to another aspect of the present disclosure, a sensor may include: a sensing device configured to acquire data from an object; a convolutional neural network (CNN)-based analog in-sensor computing device; and an analog-to-digital converter (ADC) configured to convert an output value of the analog in-sensor computing device into a digital signal, wherein the analog in-sensor computing device may include: a convolution layer including one or more convolution blocks configured to be used a predetermined number of times or more and perform a convolution operation; and an memory configured to temporarily store an analog output of the convolution layer and provide the stored analog output to a subsequent convolution layer.

The memory may include a plurality of capacitors.

The analog in-sensor computing device may further include a plurality of memories including the memory, and a plurality of convolution layers including the convolution layer and the subsequent convolution layer, and a number of the plurality of memories is less than or equal to a number of the plurality of convolution layers. The sensor may further include a processor configured to control connections of the convolution layers to allow the plurality of convolution layers to share at least one of the plurality of memories.

The memory may further include a capacitor, and the predetermined number of times may be determined based on at least one of a retention time of the capacitor or a driving frequency of the convolution blocks.

According to another aspect of the present disclosure, an electronic device may include: a sensor including sensing device configured to acquire data from an object, a convolutional neural network-based analog in-sensor computing device, and an analog-to-digital converter (ADC) configured to convert an output value of the analog in-sensor computing device into a digital signal; and a processor configured to perform one or more data processing operations on the digital signal, wherein the analog in-sensor computing device may include a convolution layer including one or more convolution blocks configured to be used a predetermined number of times or more and perform a convolution operation; and a memory configured to temporarily store an analog output of the convolution layer and provide the stored analog output to a subsequent convolution layer.

The memory may include a plurality of capacitors.

### BRIEF DESCRIPTION OF THE DRAWINGS

FIG. 1A illustrates an artificial intelligence (AI)-convolutional neural network (CNN) structure according to one or more embodiments of the present disclosure.

FIG. 1B illustrates connection of layers in the CNN shown in FIG. 1A.

FIG. 2 illustrates a CNN-based analog in-sensor computing device according to one or more embodiments.

FIG. 3A illustrates a CNN-based analog in-sensor computing device according to one or more embodiments.

FIG. 3B illustrates an example of adding a memory for compensating for leakage current to the embodiment shown in FIG. 3A.

FIG. 4 is a block diagram illustrating a sensor including an analog in-sensor computing device according to one or more embodiments.

FIG. 5 is a block diagram illustrating an electronic device including an analog in-sensor computing element according to one or more embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Terms such as first, second, and the like may be used to describe various elements, but the elements should not be limited to those terms. These terms may be used for the purpose of distinguishing one element from another element. The singular forms are intended to include the plural forms as well, unless the context clearly indicates otherwise. It will be further understood that when an element is referred to as “comprising” or “including” another element, the element is intended not to exclude one or more other elements, but to further include one or more other elements, unless explicitly described to the contrary. The term used in the embodiments such as “unit” or “module” indicates a unit for processing at least one function or operation, and may be implemented in hardware, software, or in a combination of hardware and software.

In addition, expressions such as “at least one”, for example, “at least one of a, b and c” include only a, only b, only c, a and b, a and c, b and c, or a, b and c.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

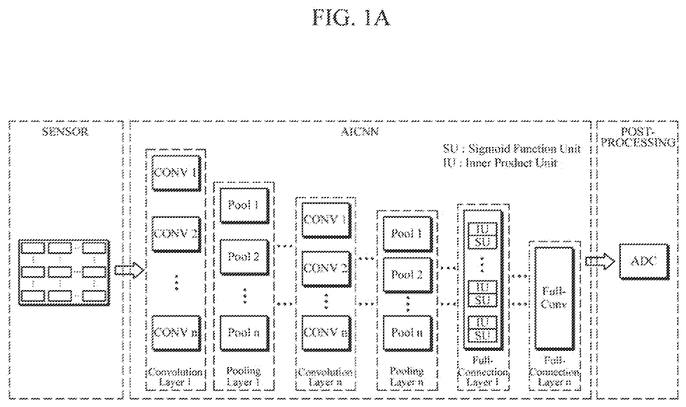

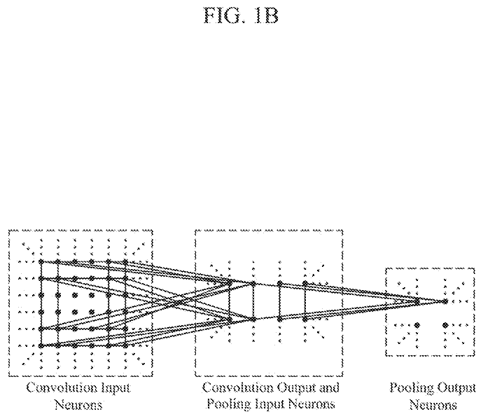

FIG. 1A illustrates the structure of artificial intelligence-convolutional neural network (AICNN) according to one or more embodiments, and FIG. 1B illustrates the connection of layers in the AICNN shown in FIG. 1A.

Referring to FIGS. 1A and 1B, the AICNN receives an image (e.g., a raw image or an original image) from a sensor including a plurality of pixels. The image provided to the AICNN may contain pixel-level image data acquired from each of the plurality of pixels in the sensor. The AICCN may be a CNN-based analog signal processing device, in which an output from each layer is directly connected to an input of a subsequent layer, and all operations are calculated in an analog circuit, allowing for high power efficiency and fast output generation.

In this AICNN structure, all operations may be processed in parallel. While the parallel processing of AICNNs offers efficiency benefits, it presents a trade-off with chip area requirements because as the model size increases (e.g., more layers, large input dimensions), the number of convolutional operators (e.g., convolution blocks) increases proportionally. Consequently, this leads to a growing demand for semiconductor chip area to accommodate the additional resources involved, potentially posing a challenge for device miniaturization and embedded applications.

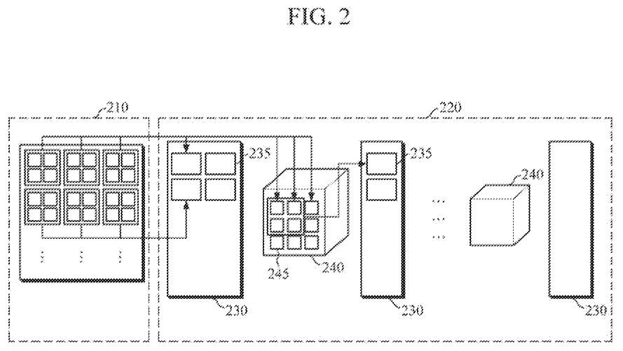

FIG. 2 illustrates a CNN-based analog in-sensor computing device according to other embodiments of the present disclosure.

Referring to FIG. 2, a CNN-based analog in-sensor computing device 220 may include a convolution layer 230 configured to perform a CNN operation using data obtained from a sensing device 210 through an object as an input, and a memory 240 connected to the convolution layer and configured to store an analog output of the convolution layer. The memory 240 may include at least one capacitor to store the analog output of the convolution layer. For example, instead of storing binary digital information (0 or 1), the capacitor may store electrical charge in a continuous range of values, which represent various information levels in an analog domain. The level of stored electrical charge (i.e., capacitance) may be used as the analog output value.

The convolution layer 230 may include one or more convolution blocks 235 that are used a predetermined number of times or more and perform convolution operations. The convolution blocks 235 may be also referred to as convolution operators.

The convolution block 235 may be formed as a crossbar array, and input values of the rows and columns of the crossbar array may be determined considering the number of channels, which are input data, the number of convolution filters, etc., to maximize the analog parallel computation capacity.

For example, if the input data are received through multiple input channels, the values of each of the input channels may be formed in each row of the crossbar array, and each convolution filter may be formed in each column.

Furthermore, if the input data is received through only one channel, the number of rows in the crossbar array may be determined based on the size of the convolution filter. For example, the number of rows in the crossbar array may be formed to correspond to the size of the convolution filter (e.g., 9 for a 3×3 filter).

At least one convolution block 235 may perform a convolution operation a predetermined number of times or more.

The predetermined number of times represents the number of convolution operations that the convolution block 235 can perform for each signal input from the sensing device 210 and is related to the number of convolution blocks 235 required to operate a CNN model. In other words, the predetermined number of times may indicate convolution operations per input feature map per convolution block, and may be referred to as the number of convolution operations per convolution block. In other words, by repetitively using the same convolution block, the number of convolution blocks required for use can be reduced, resulting in a decrease in the size of the area of a semiconductor chip.

The predetermined number of times may be determined based on at least one of the retention time, which represents the time to maintain the charge of a capacitor forming the memory 240, and the driving frequency of the convolution block 235.

For example, the retention time of a capacitor may be calculated using specifications of the capacitor (e.g., capacitor density, leakage current, etc.), the size of an output feature map (OFM) of each layer in the CNN, the weight of the CNN model, activation, precision, a driving voltage of the device, and the like.

The number of convolution operations per convolution block n may be predetermined by taking into consideration the calculated retention time of a capacitor, a time scale value for adjusting the retention time due to the driving voltage, and the frequency of the crossbar array used in the convolution block 235. The number of convolution operations per convolution may be expressed by Equation 1 below:

$$n = α \frac{{F}_{crossbar} \times {V}_{data} \times {D}_{cap} \times {A}_{cap}}{2 \times {I}_{leak} \times {2}^{precision} \times {S}_{output}} \qquad [ Equation 1 ]$$

Here, F_{crossbar} represents the frequency of the crossbar array, V_{data} represents the driving voltage, D_{cap} represents the capacitor density, Iₗₑₐₖ represents the leakage current of the capacitor, Sₒᵤₜₚᵤₜ represents the size of the OFM, precision represents a quality indicator of the CNN model, and a represents an arbitrary coefficient.

In other words, as capacitors with increased density and lower leakage current are used, as a CNN model uses filters with larger strides to reduce the OFM size, and as a crossbar array with a higher frequency is employed, the number of convolution operations per convolution block may increase. Accordingly, this may lead to a reduction in the area of the semiconductor chip.

For example, when a 2 mm×2 mm semiconductor chip is implemented using a tactile sensor with an input of 112×112 pixels, the CNN model utilizes the last three layers of a ResNet-18 model for extracting tactile features. The convolution block uses a 45-MHz crossbar array based on 28 nm eFlash technology. The capacitors have a specification of 100 fF per 23 μm² of metal-oxide-metal (MOM) and a leakage current of 100 pA, precision is 4 bits, a driving voltage is 1 V, and a retention time of the capacitor is 12.05 μs. In this case, the predetermined number (n) of times for the convolution block may be determined to be 5.

TABLE 1

| | Present embodiment | | Conventional method | | |
|---|---|---|---|---|---|
| | Use each CB five times | | Use each CB once | | Area |
| | The number | Total | The number | Total | reduc- |
| | of convolu- | area | of convolu- | area | tion |
| | tion blocks | (mm²) | tion blocks | (mm²) | (%) |
| First layer | 594 | 1.52 | 2916 | 1.60 | 4.79 |
| Second layer | 1125 | 0.87 | 5625 | 3.08 | 71.68 |
| Third layer | 1035 | 0.78 | 4761 | 2.60 | 69.94 |

Table 1 compares a method according to an embodiment of the present disclosure, which involves using each convolution block five times, with the conventional method of using each convolution block only once. It can be observed that the method according to the embodiment reduces the area by an average of 48.8% (up to 71.68%) compared to the conventional method. Additionally, the conventional method requires an area of 7.28 mm², making it impractical for implementation on a 2 mm×2 mm single semiconductor chip, whereas the proposed method requires an area of 3.17 mm², making it feasible for implementation on a 2 mm×2 mm chip.

To ensure that the convolution block 235 is used a predetermined number of times or more, a method is needed that temporarily stores the output of the convolution layer, rather than the conventional method where the output of each layer is directly connected to the input of the subsequent layer. For this purpose, the analog in-sensor computing device may include the memory 240 between layers of the convolution block 235.

The memory 240 may temporarily store the output of the convolution layer 230, and allow the convolution layer positioned next to the current convolution layer to read out the data from the memory 240. The memory 240 may be arranged in the same quantity as the number of convolution layers.

The memory 240 may include a plurality of capacitors 245. For example, the capacitors with the latest quantization method and high density may temporarily store an output value of a sub-4 bit activation function.

The number of capacitors 245 may be determined based on the OFM of the convolution layer 230 stored in the capacitor 245. For example, if the OFM has a size of 5×5, 25 or more capacitors may be used.

Meanwhile, the capacitors 245 may experience leakage current which is a small amount of current flowing through an oxide layer serving as a dielectric within the device. To acquire accurate data, correction for this leakage current may be necessary.

For example, the memory 240 may ensure that the capacitors 245 used are randomly selected. For example, a random number generator (RNG) may be used to generate random values mapped to the addresses or indices of capacitors within the memory 240. If only predetermined capacitors are mostly used, the leakage current of heavily used capacitors may increase, leading to a decrease in the hardware performance of the memory. Thus, the capacitors may be randomly selected to distribute the usage across capacitors. The random selection mechanism for capacitors in the memory 240 is provided to ensure a more balanced and efficient usage, thereby addressing potential issues related to leakage current and hardware performance degradation.

Moreover, the memory 240 may compensate for leakage current by upscaling or downscaling the output of the convolution layer 230 when the output is written or read in a predetermined capacitor 245.

For example, upscaling may be performed to store a value larger than the output to be written in the capacitor first. Later, during readout from the capacitor, downscaling may be performed to compensate for leakage current. The degree of leakage current, temperature, driving voltage, or the like needs to be taken into account for upscaling or downscaling, and the method for upscaling or downscaling is not limited to this.

In another embodiment, two or more memories may be provided, and the number of memories arranged may be less than the number of convolution layers. In this case, to arrange fewer memories than the convolution layers, a controller (e.g., a processor or a CPU) may be included to control the connections of the convolution layers to allow two or more convolution layers to share one memory.

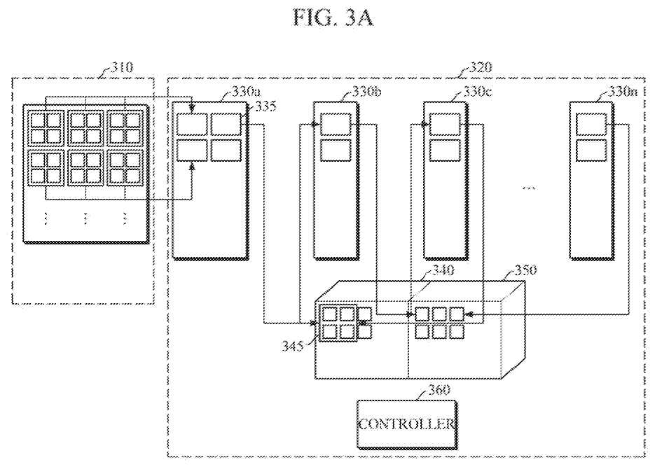

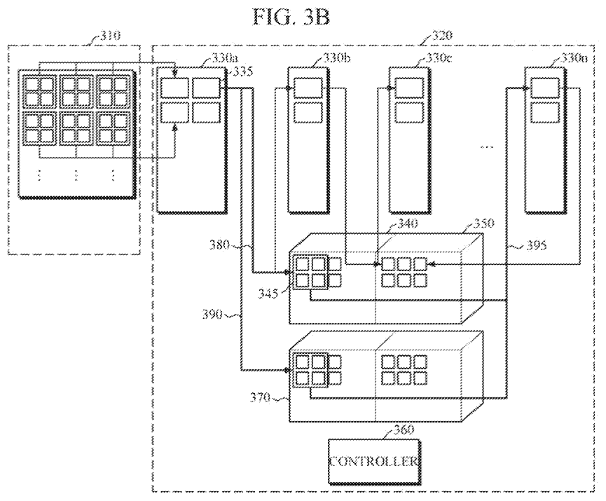

FIG. 3A illustrates a CNN-based analog in-sensor computing device according to another embodiment.

Referring to FIG. 3A, a CNN-based analog in-sensor computing device 320 may include convolution layers 330a, 330b, 330c, . . . and, 330n configured to perform a CNN operation using data obtained from a sensing device 310 through an object as input, and a first memory 340 and a second memory 350 that are connected to the convolution layers 330a, 330b, 330c, . . . and, 330n and store outputs of the convolution layers. Also, the CNN-based analog in-sensor device 320 may include a controller (e.g., a processor or a CPU) 360 to control the connections between the convolution layers and the memories, allowing the first and second analog memories 340 and 350 to be shared among the convolution layers.

For example, the controller 360 may control such that an output of a first convolution layer 330a is stored in the first memory 340, the stored output of the first convolution layer 330a is then input to a second convolution layer 330b, and an output of the second convolution layer 330b is stored in the second memory 350. Also, the controller 360 may control such that the stored output of the second convolution layer 330b is input to a third convolution layer 330c and an output of the third convolution layer 330c is stored in the first memory 340, allowing reuse of the first memory 340. Thus, the controller 360 may control the memory to be shared among the convolution layers.

Moreover, the total number of capacitors 345 included in the first memory 340 and the second memory 350 may be determined based on the sizes of the OFMs of the convolution layers 330. For example, the total number of capacitors 345 may be determined such that the memory capacity of the total number of capacitors 345 are greater than or equal to the sum of the data size of the OFM of the last convolution layer of the CNN and the data size of the OFM of the convolution layer immediately above the last convolution layer. For example, if the data size of the OFM of the last convolution layer of the CNN is 5×5 and the size of the OFM of the convolution layer immediately preceding the last convolution layer is 4×4, the total number of capacitors 345 may be determined to be 41 (25+16=41) or more. However, the method of determining the number of capacitors is not limited to this example.

FIG. 3B illustrates an example of adding a memory for compensating for leakage current to the embodiment shown in FIG. 3A.

The analog in-sensor computing device may further include a plurality of reference memories 370 to compensate for leakage current of capacitors.

For example, an output of the same convolution layer is stored not only in a main memory (e.g., the first memory 340) but also in the reference memory 370. The time sequence of the convolution layer output 380 stored in the main memory (e.g., the first memory 340) is reversed compared to the time sequence of the convolution layer output 390 stored in the reference memory 370. During readout of the output, the output 380 stored in the main memory and the output 390 stored in the reference memory may be averaged to produce an output 395, which is then transferred as input to the next convolution layer, compensating for leakage current according to the storage time of the capacitor.

A conventional CNN-based analog signal processing device requires numerous convolutional operators to obtain accurate output values, leading to an increase in the chip's area. According to the above embodiment of the analog in-sensor computing device including an memory, enabling the multiple reuses of convolution blocks, it has not only advantages of analog signal processing, such as high power efficiency and fast output generation, but also reduces the number of convolution blocks required for operations, leading to a decrease in the semiconductor chip's area.

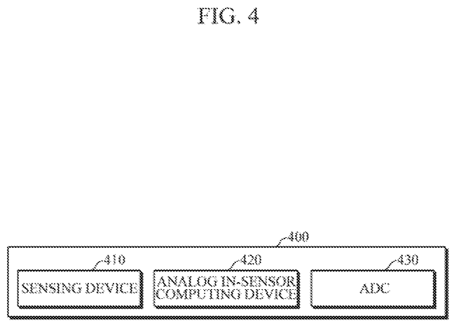

FIG. 4 is a block diagram illustrating a sensor including an analog in-sensor computing device according to an embodiment.

Referring to FIG. 4, a sensor 400 may include a sensing device 410, an analog in-sensor computing device 420, and an analog-to-digital converter (ADC) 430.

The sensing device 410 is a device that acquires data sensed from a target object, which may include various data such as contact signals from the target object and optical signals reflected from the target object.

The analog in-sensor computing device 420 is a CNN-based analog in-sensor computing device that performs low-power analog operations on data acquired from the sensing device 410. It may include one or more convolution blocks configured to be used a predetermined number of times or more and perform convolution operations. It may also include a memory that temporarily stores the output of the convolution layer and allows the stored output to be read and input by a convolution layer positioned next to the current convolution layer.

The predetermined number of times may be determined based on at least one of retention time of a capacitor or a driving frequency of the convolution blocks.

The memory is formed of a plurality of capacitors, and two or more analog memories may be provided. The number of analog memories arranged may be less than or equal to the number of convolution layers. The analog in-sensor computing device may further include a controller configured to control the connections of convolution layers to allow two or more convolution layers to share one memory.

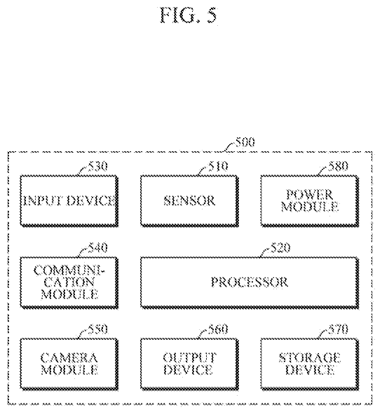

FIG. 5 is a block diagram illustrating an electronic device including an analog in-sensor computing element according to an embodiment.

An electronic device described below may include at least one of, for example, a smartphone, a tablet personal computer (PC), a mobile phone, a video phone, an electronic-book (e-book) reader, a desktop PC, a laptop PC, a netbook computer, a workstation, a server, a personal digital assistant (PDA), a portable multimedia player (PMP), an MP3 player, mobile medical equipment, a camera, or a wearable device. Examples of the wearable device may include at least one of an accessory type (e.g., a watch, a ring, a bracelet, an anklet, a necklace, glasses, contact lenses, head-mounted device (HMD), etc.), a fabric or cloth-integrated type (e.g., electronic clothing, etc.), a body-attached type (e.g., a skin pad, a tattoo, etc.), a body implantable circuit, or the like. However, the electronic device is not limited to these examples, and it may include at least one of various medical equipment, for example, various portable medical measurement devices (a blood glucose meter, a heart rate measuring device, a blood pressure measuring device, a body temperature measuring device, etc.), magnetic resonance angiography (MRA), magnetic resonance imaging (MRI), computed tomography (CT), an imaging device, or an ultrasonic device. However, the electronic device is not limited to the above-described devices.

Referring to FIG. 5, the electronic device 500 may include a sensor 510, a processor 520, an input device 530, a communication module 540, a camera module 550, an output device 560, a storage device 570, and a power module 580. All the components of the electronic device 500 may be integrally mounted in a specific device or may be distributed in two or more devices.

The sensor 510 may detect an operating state of the electronic device 500 (e.g., temperature, power, etc.), or external environmental conditions (e.g., user state) and generate electrical signals and/or data corresponding to the detected state. The sensor 510 may include a tactile sensor, an image sensor, a gyro sensor, a pulse wave sensor, an acceleration sensor, a fingerprint sensor, and the like, and is not limited to these examples.

For example, the sensor 510 may include a sensing device that acquires data from a target object, a CNN-based analog in-sensor computing device that performs low-power analog operations on the acquired data, and an ADC that converts the output of the analog in-sensor computing device into a digital signal.

The analog in-sensor computing device includes one or more convolution blocks that are used a predetermined number of times or more and perform convolution operations. It may also include a convolution layer that temporarily stores the output of the convolution layer and allows the stored output to be read and input by a convolution layer positioned next to the current convolution layer. Here, the memory may be formed of a plurality of capacitors.

The processor 520 may control the components connected to the processor 520 by executing programs stored in the storage device 570 and perform various data processing or computations. For example, the processor 520 may perform one or more data processing operations on the digital signal acquired from the sensor 510.

The processor 520 may include a main processor, e.g., a central processing unit (CPU) or an application processor (AP), etc., and an auxiliary processor, e.g., a graphics processing unit (GPU), an image signal processor (ISP), sensor hub processor, or a communication processor (CP), etc., which is operable independently from, or in conjunction with, the main processor.

The input device 530 may receive a command and/or data to be used by each component of the electronic device 500, from a user and the like. The input device 530 may include, for example, a microphone, a mouse, a keyboard, or a digital pen (e.g., a stylus pen, etc.).

The communication module 540 may support establishment of a direct (e.g., wired) communication channel and/or a wireless communication channel between the electronic device 500 and other electronic device, a server, or the sensor 510 within a network environment, and performing of communication via the established communication channel. The communication module 540 may include one or more communication processors that are operable independently from the processor 520 and supports a direct communication and/or a wireless communication.

The communication module 540 may include a wireless communication module, e.g., a cellular communication module, a short-range wireless communication module, or a global navigation satellite system (GNSS) communication module, etc., and/or a wired communication module, e.g., a local area network (LAN) communication module, a power line communication (PLC) module, and the like. These various types of communication modules may be integrated into a single chip, or may be separately implemented as multiple chips. The wireless communication module may identify and authenticate the electronic device 500 in a communication network using subscriber information (e.g., international mobile subscriber identity (IMSI), etc.) stored in a subscriber identification module.

The camera module 550 may capture still images or moving images. The camera module 550 may include a lens assembly having one more lenses, image sensors, image signal processors, and/or flashes. The lens assembly included in the camera module 550 may collect light emanating from a subject to be imaged.

The output device 560 may visually/non-visually output data generated or processed by the electronic device 500. The output device 560 may include a sound output device, a display device, an audio module, and/or a haptic module.

The sound output device may output sound signals to the outside of the electronic device 500. The sound output device may include a speaker and/or a receiver. The speaker may be used for general purposes, such as playing multimedia or playing record, and the receiver may be used for incoming calls. The receiver may be implemented separately from, or as part of, the speaker.

The display device may visually provide information to the outside of the electronic device 500. The display device may include, for example, a display, a hologram device, or a projector and control circuitry to control the devices. The display device may include touch circuitry adapted to detect a touch, and/or sensor circuitry (e.g., pressure sensor, etc.) adapted to measure the intensity of force incurred by the touch.

The audio module may convert a sound into an electrical signal or vice versa. The audio module may obtain the sound via the input device, or may output the sound via the sound output device, and/or a speaker and/or a headphone of another electronic device directly or wirelessly connected to the electronic device 500.

The haptic module may convert an electrical signal into a mechanical stimulus (e.g., vibration, motion, etc.) or electrical stimulus which may be recognized by a user by tactile sensation or kinesthetic sensation. The haptic module may include, for example, a motor, a piezoelectric element, and/or an electric stimulator.

The storage device 570 may store operating conditions required for operating the sensor 510, and various data required for other components of the electronic device 500. The various data may include, for example, software and input data and/or output data for a command related thereto. The storage device 570 may include a volatile memory and/or a non-volatile memory.

The power module 580 may manage power supplied to the electronic device 500. The power module may be implemented as least part of, for example, a power management integrated circuit (PMIC). The power module 580 may include a battery, which may include a primary cell which is not rechargeable, a secondary cell which is rechargeable, and/or a feel cell.

While not restricted thereto, an example embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an example embodiment may be written as a computer program transmitted over a computer-readable transmission medium, such as a carrier wave, and received and implemented in general-use or special-purpose digital computers that execute the programs. Moreover, it is understood that in example embodiments, one or more units of the above-described apparatuses and devices can include circuitry, a processor, a microprocessor, etc., and may execute a computer program stored in a computer-readable medium.

What is claimed is:

1. A convolutional neural network (CNN)-based analog in-sensor computing device comprising:
a convolution layer comprising one or more convolution blocks configured to be used a predetermined number of times or more and perform a convolution operation; and
a memory configured to temporarily store an analog output of the convolution layer and provide the stored analog output to a subsequent convolution layer.

2. The analog in-sensor computing device of claim 1, wherein the memory comprises a plurality of capacitors.

3. The analog in-sensor computing device of claim 2, wherein a number of the plurality of capacitors is set based on a data size of an output feature map of the convolution layer.

4. The analog in-sensor computing device of claim 2, wherein in the memory, a capacitor in which the analog output of the convolution layer is to be stored is randomly selected from the plurality of capacitors.

5. The analog in-sensor computing device of claim 2, wherein in the memory, the analog output of the convolution layer is upscaled or downscaled before being stored in one of the plurality of capacitors.

6. The analog in-sensor computing device of claim 1, further comprising a plurality of memories comprising the memory, and a plurality of convolution layers comprising the convolution layer and the subsequent convolution layer,
wherein a number of the plurality of memories is equal to a number of the plurality of convolution layers.

7. The analog in-sensor computing device of claim 1, further comprising a plurality of memories comprising the memory, and a plurality of convolution layers comprising the convolution layer and the subsequent convolution layer,
wherein a number of the plurality of memories is less than a number of the plurality of convolution layers.

8. The analog in-sensor computing device of claim 7, further comprising a processor configured to control connections of the plurality of convolution layers to allow the plurality of convolution layers to share at least one of the plurality of memories.

9. The analog in-sensor computing device of claim 8, wherein the plurality of memories comprise a first memory and a second memory, memory capacity of a total number of capacitors included in the first memory and the second memory is greater than or equal to a sum of a data size of an output feature map of a last convolution layer of a convolutional neural network comprising the plurality of convolution layers and a data size of an output feature map of a convolution layer immediately preceding the last convolution layer.

10. The analog in-sensor computing device of claim 1, wherein the memory comprises a main memory and a reference memory, a time sequence of an output stored in the main memory is reversed compared to a time sequence of an output stored in the reference memory, and the output stored in the main memory and the output stored in the reference memory are averaged when the output is read.

11. The analog in-sensor computing device of claim 1, wherein the convolution block comprises a crossbar array and when input data is received through multiple input channels, a value of each of the multiple input channels is formed in each row of the crossbar array, and each column of the crossbar array is formed as a convolution filter.

12. The analog in-sensor computing device of claim 1, wherein the convolution block comprises a crossbar array, and when input data is received through a single channel, a number of rows of the crossbar array is determined based on a size of a convolution filter.

13. The analog in-sensor computing device of claim 1, wherein the memory comprises a capacitor, and
the predetermined number of times is determined based on at least one of a retention time of the capacitor or a driving frequency of the one or more convolution blocks.

14. The analog in-sensor computing device of claim 13, wherein the retention time of the capacitor is determined based on at least one of specifications of the capacitor, a size of each layer of a convolutional neural network, or a driving voltage.

15. A sensor comprising:
a sensing device configured to acquire data from an object;
a convolutional neural network (CNN)-based analog in-sensor computing device; and
an analog-to-digital converter (ADC) configured to convert an output value of the analog in-sensor computing device into a digital signal,
wherein the analog in-sensor computing device comprises
a convolution layer comprising one or more convolution blocks configured to be used a predetermined number of times or more and perform a convolution operation; and
a memory configured to temporarily store an analog output of the convolution layer and provide the stored analog output to a subsequent convolution layer.

16. The sensor of claim 15, wherein the memory comprises a plurality of capacitors.

17. The sensor of claim 15, wherein the analog in-sensor computing device further comprises a plurality of memories comprising the memory, and a plurality of convolution layers comprising the convolution layer and the subsequent convolution layer, and
a number of the plurality of memories is less than or equal to a number of the plurality of convolution layers, and
the sensor further comprises a processor configured to control connections of the convolution layers to allow the plurality of convolution layers to share at least one of the plurality of memories.

18. The sensor of claim 15, wherein the memory comprises a capacitor, and
the predetermined number of times is determined based on at least one of a retention time of the capacitor or a driving frequency of the convolution blocks.

19. An electronic device comprising:
a sensor comprising sensing device configured to acquire data from an object, a convolutional neural network-based analog in-sensor computing device, and an analog-to-digital converter (ADC) configured to convert an output value of the analog in-sensor computing device into a digital signal; and
a processor configured to perform one or more data processing operations on the digital signal,
wherein the analog in-sensor computing device comprises
a convolution layer comprising one or more convolution blocks configured to be used a predetermined number of times or more and perform a convolution operation; and
a memory configured to temporarily store an analog output of the convolution layer and provide the stored analog output to a subsequent convolution layer.

20. The electronic device of claim 19, wherein the memory comprises a plurality of capacitors.
